(19) United States
(12) Patent Application Publication
(10) Pub. No.: US 2007/0114870 A1
(43) Pub. Date: May 24, 2007

(54) Induction motor capable of utilizing magnetic fluxes of end-turns of a stator to increase torque of a rotor

(75) Inventor: Seung Yeol Lee, Seoul (KR)

Correspondence Address: BACON & THOMAS, PLLC, 625 SLATERS LANE, FOURTH FLOOR, ALEXANDRIA, VA, 22314, US

(73) Assignee: DAEWOOD ELECTRONIC CORPORATION, Seoul (KR)

(21) Appl. No.: 11/603,005

(22) Filed: Nov. 22, 2006

(30) Foreign Application Priority Data
Nov. 23, 2005 (KR) 10-2005-0112287
Nov. 23, 2005 (KR) 10-2005-0112289

(51) Int. Cl. H02K 15/12; H02K 17/00

(52) U.S. Cl. 310/166; 310/44; 310/261; 310/211

(57) ABSTRACT

An induction motor includes a stator having stator cores and coils wound on the stator cores to leave end-turns, and a rotor rotatably provided at an inner side of the stator with a gap left between the stator and the rotor. The rotor has a rotor core provided at an axial end with an end-turn utilizing portion extending radially outwardly in a confronting relationship with the end-turns of the stator with a gap left therebetween, so that magnetic fluxes generated in the end-turns flow through the end-turn utilizing portion of the rotor core. The rotor core is made of compressed soft-magnetic powder.

### FIELD OF THE INVENTION

The present invention relates to an induction motor making effective use of end-turns; and, more particularly, to an induction motor capable of utilizing magnetic fluxes of end-turns of a stator to increase a torque of a rotor.

### BACKGROUND OF THE INVENTION

In general, an electric motor, which converts an electric energy to a mechanical energy to thereby generate a rotation force, has been extensively used in household electronic products and industrial equipments. The electric motor is largely divided into an alternating current (AC) motor and a direct current (DC) motor.

As one kind of the AC motor, there is known an induction motor in which an electric current is induced in a secondary winding by electromagnetic induction of a primary winding of a coil connected to a power supply and a rotational torque is obtained by interaction between the current induced in the secondary winding and rotating magnetic fields.

A conventional induction motor will now be described with reference to FIG. 1.

FIG. 1 is a cross-sectional view of the conventional induction motor. As shown, the conventional induction motor 10 includes a stator 11 fixedly secured to a housing 14, a rotor 12 rotatably provided at the inner side of the stator 11 with a gap left therebetween, and a shaft 13 press-fitted to a center portion of the rotor 12 for rotation therewith.

The stator 11 includes coils 11a supplied with an alternating current for creating rotating magnetic fields and stator cores 11b made of a magnetic material, magnetic fluxes generated by the rotating magnetic fields of the coils 11a flowing through the stator cores 11b.

Each of the stator cores 11b is formed by stacking a multiple number of identically shaped silicon steel plates in an axial direction. A plural number of radial slots (not shown) are formed at intervals along an inner circumferential surface of each of the stator cores 11b. The coils 11a are wound in the slots by using a winding method such as distributed winding, concentrated winding, coaxial winding or the like.

The rotor 12 includes rotor conductors 12a for generating a torque through interaction between a current induced by the coils 11a and magnetic fluxes, and a rotor core 12b made of a magnetic material through which the magnetic fluxes flow. The rotor conductors 12a are attached to the rotor core 12b.

The rotor conductors 12a are made of high conductivity metal, such as aluminum and copper, or a magnet.

The rotor core 12b is formed by stacking a multiple number of identically shaped silicon steel plates in an axial direction. A plural number of radial slots (not shown) are formed at intervals on an outer peripheral surface or at an inner side of the rotor core 12b. As similar to the coils 11a, the rotor conductors 12a are fitted in the slots in parallel with the axial direction.

The rotor core 12b is provided at its opposite ends with end rings 12c that interconnect the rotor conductors 12a fitted inside the rotor core 12b to form a circuit.

The end rings 12c are usually made of aluminum which allows the end rings 12c to be integrally formed with the rotor conductors 12a by a diecasting method in case of the rotor conductors 12a being metal.

The shaft 13 is inserted through and fixed to the rotor core 12b, and the shaft 13 is rotatably supported through bearings 14b on shaft seats 14a formed at opposite sides of the housing 14.

The operation of the conventional induction motor 10 will now be described. If an alternating current is applied to the coils 11a, magnetic fields are created in a direction perpendicular to a motor axis and rotating magnetic fluxes are generated through the stator cores 11b. The rotating magnetic fluxes are interlinked with the rotor conductors 12a of the rotor 12 through a gap between the stator core 11b and the corresponding rotor conductor 12a, thereby inducing an electric current in the rotor conductors 12a. At this time, the electric current induced in the rotor conductors 12a cooperates with the magnetic fluxes to generate a torque in the rotor 12 according to Fleming's left hand rule.

In the conventional induction motor 10, end-turns 11c are formed at opposite ends of each of the stator cores 11b. The end-turns 11c form a circuit by interconnecting the coils 11a wound in the respective slots of the stator cores 11b. In such an induction motor 10, a multiple number of poles need to be formed on the stator 11 in order to create the rotating magnetic fields. To this end, the coils 11a are not wound through the neighboring two slots of the stator cores 11b but wound through two slots arranged distant from each other with one or more other slots disposed therebetween. For this reason, use of the end-turns 11c is unavoidable, while the length thereof may vary depending on the method of winding the coils 11a.

In the induction motor 10, however, the end-turns 11c occupy a substantial length of the coils 11a wound on the stator 11, despite the fact that the magnetic fluxes created by the end-turns 11c cannot serve as an effective magnetic flux contributing to the torque of the rotor 12. Accordingly, the end-turns 11c are of no use in improving efficiency of the induction motor 10 but merely increase a copper loss, i.e., an intrinsic resistance, of the coils 11a.

### SUMMARY OF THE INVENTION

It is, therefore, an object of the present invention to provide an induction motor capable of making effective use of end-turns.

In accordance with an aspect of the present invention, there is provided an induction motor including a stator having stator cores and coils wound on the stator cores to leave end-turns, and a rotor rotatably provided at an inner side of the stator with a gap left between the stator and the rotor, wherein: the rotor has a rotor core provided at an axial end with an end-turn utilizing portion extending radially outwardly in a confronting relationship with the end-turns of the stator with a gap left therebetween, so that magnetic fluxes generated in the end-turns flow through the end-turn utilizing portion of the rotor core.

Preferably, the rotor core is made of compressed soft-magnetic powder. Further, the rotor core may be also provided at the other axial end with the end-turn utilizing portion.

In accordance with an aspect of the present invention, there is provided an induction motor including a stator having stator cores and coils wound on the stator cores to leave end-turns, and a rotor rotatably provided at an inner side of the stator with a gap left between the stator and the rotor, wherein: each of the stator cores is provided at an axial end with an end-turn utilizing portion axially extending therefrom in a confronting relationship with one of the end-turns; and a rotor has a rotor core axially extended to face the end-turn utilizing portions of the stator with a gap left therebetween, so that the magnetic fluxes generated in the end-turns are transferred through the end-turn utilizing portions to the rotor core.

Preferably, the stator cores are made of compressed soft-magnetic powder. Further, each of the rotor cores may be also provided at the other axial end with the end-turn utilizing portion.

### BRIEF DESCRIPTION OF THE DRAWINGS

The above and other objects and features of the present invention will become apparent from the following description of preferred embodiments, given in conjunction with the accompanying drawings, in which:

FIG. 1 is a cross-sectional view of a conventional induction motor;

FIG. 2 is a cross-sectional view of an induction motor in accordance with one embodiment of the present invention, which makes effective use of end-turns;

FIG. 3 is a perspective view depicting a rotor of the induction motor illustrated in FIG. 2;

FIG. 4 is a cross-sectional view of an induction motor in accordance with another embodiment of the present invention, which makes effective use of end-turns; and

FIG. 5 is a cross-sectional view taken along the line V-V in FIG. 4.

### DETAILED DESCRIPTION OF THE PREFERRED EMBODIMENTS

Hereinafter, preferred embodiments of the present invention will be described with reference to the accompanying drawings.

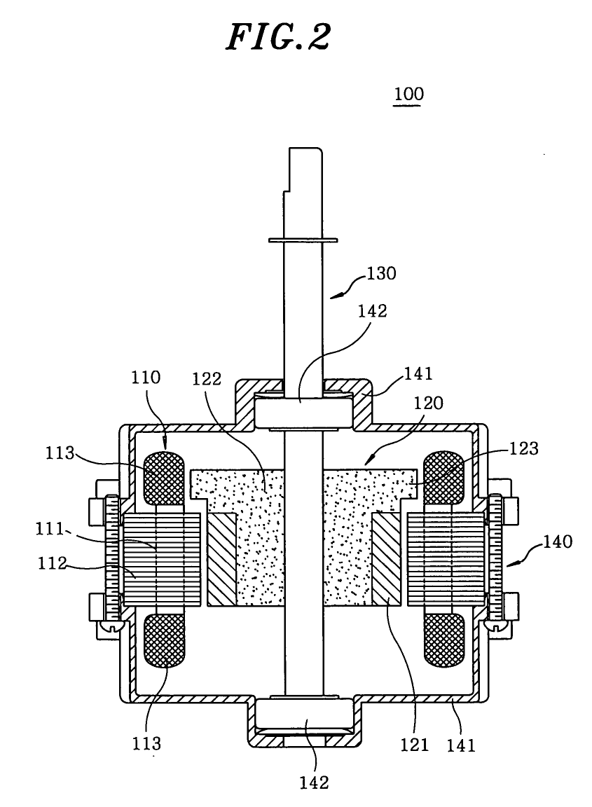

FIG. 2 is a cross-sectional view of an induction motor 100 in accordance with a first embodiment of the present invention, which makes effective use of end-turns of a stator to increase torque of a rotor. As illustrated, the induction motor 100 in accordance with the first embodiment includes a housing 140, a stator 110 fixedly secured to the inside of the housing 140, and a rotor 120 press-fitted onto a shaft 130 rotatably supported on shaft seats 141 of the housing 140 through bearings 142, the rotor 120 being disposed at the inner side of the stator 110 with a gap left between the stator 110 and the rotor 120 and the rotor 120 and the shaft 130 being rotatable together. The rotor 120 has a rotor core 122 made of compressed soft magnetic powder and the rotor core 122 is provided at an axial end with an end-turn utilizing portion 123 protruded to confront end-turns of the stator 110. Although the end-turn utilizing portion 123 is formed at one axial end of the rotor core 122 in this embodiment, it should be noted that it may be formed at both axial end of the rotor core 122.

The stator 110 includes coils 111 supplied with an alternating current for creating rotating magnetic fields and stator cores 112 made of a magnetic material, magnetic fluxes generated by the rotating magnetic fields of the coils 111 flowing through the stator cores 112. Each of the coils 111 is wound in a plurality of slots (not shown) radially formed along an inner circumferential surface of each of the stator cores 112, thus leaving end-turns 113 at opposite axial ends of each of the stator cores 112.

The rotor 120 includes rotor conductors 121 for generating a torque through interaction between an electric current induced by the coils 111 and magnetic fluxes, and a rotor core 122 made of a magnetic material through which the magnetic fluxes flow.

The rotor conductors 121 are made of high conductivity metal, such as aluminum and copper, or a magnet. As similar to the coils 111, the rotor conductors 121 are fitted in slots of the rotor core 122 in parallel with an axial direction. The rotor conductors 121 are attached to an outer peripheral surface of the rotor core 122. Alternatively, the rotor conductors 121 may be disposed in the rotor core 122.

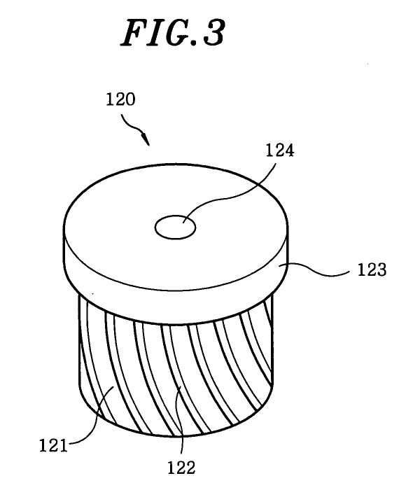

As shown in FIGS. 2 and 3, the rotor core 122 extends radially outwardly at one axial end, e.g., the top end, toward the end-turns 113 of the stator 110, thus providing the end-turn utilizing portion 123 that is axially offset with respect to the stator cores 112 and confronts the end-turns 113 with a gap left therebetween. The rotor core 122 is provided with a plurality of slots into which the rotor conductors 121 are fitted and a shaft-receiving hole 124 through which the shaft 130 is inserted for fixation thereto.

With such arrangements, magnetic fluxes of the end-turns 113 flow through the end-turn utilizing portion 123 to induce an electric current in the rotor conductors 121.

The rotor core 122 is molded by compressing soft magnetic powder in such a manner as to form the slots (not shown), the shaft-receiving hole 124 and the end-turn utilizing portion 123. The iron-based particles of the soft magnetic powder are coated with an insulating material for the purpose of electrical insulation.

In order to compressively mold the soft magnetic powder into the rotor core 122, a molding cavity corresponding in shape to the rotor core 122 is provided within a compression-molding machine, and the soft magnetic powder is filled in the molding cavity and then compressed by a punch or the like to form the rotor core 122 having the slots (not shown), the shaft-receiving hole 124 and the end-turn utilizing portion 123. In this process, a lubricant and/or a binder may be added to the soft magnetic powder.

By the process of compression-molding the rotor core 122, the soft magnetic powder is made to form a soft magnetic composite (“SMC”) having a three-dimensional shape. As opposed to a conventional rotor core made of silicon steel plates, the rotor core 122 thus molded provides an increased flexibility of design, thus making it possible to form the end-turn utilizing portion 123 with ease.

Hereinafter, there will be described the operation of the induction motor having the afore-mentioned structure.

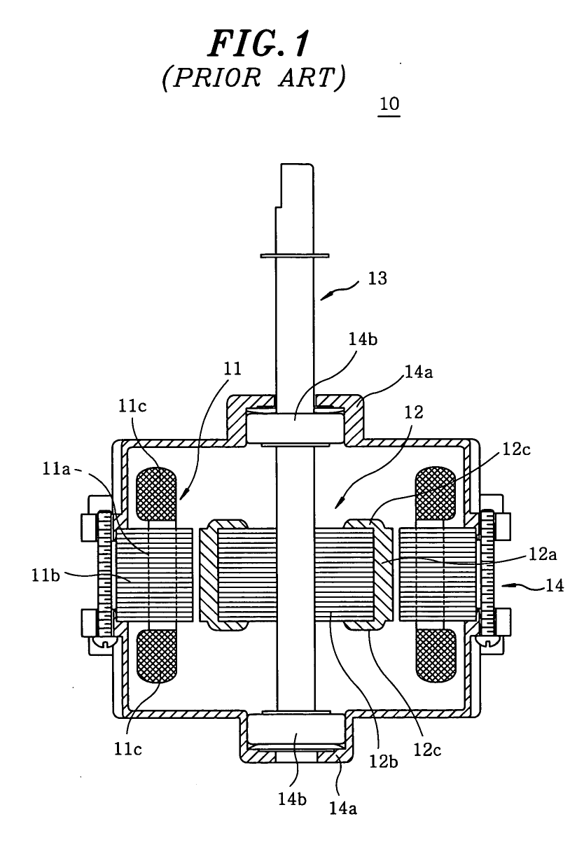

If an alternating current is applied to the coils 111, rotating magnetic fluxes are formed in the stator cores 112 and interlinked with the rotor conductors 121 though the gap therebetween, thereby inducing an electric current in the rotor conductors 121. The electric current induced in the rotor conductors 121 cooperates with the magnetic fluxes to generate a torque of the rotor 120. At this time, the magnetic fluxes formed in the end-turns 113 are allowed to flow through the gap and through the end-turn utilizing portion 123 to induce an electric current in the rotor conductors 121. This improves efficiency of the induction motor compared with a conventional induction motor as shown in FIG. 1 wherein the magnetic fluxes of the end-turns are not utilized.

Thus, in accordance with the present embodiment, the magnetic fluxes generated in the end-turns 113 are effectively utilized to increase the torque of the rotor 120, thereby improving efficiency of the induction motor 100.

As described above, in the first embodiment of the present invention, since the induction motor 100 includes the rotor 120 having the end-turn utilizing portion 123 confronting the end-turns 113 of the stator 110, magnetic fluxes generated in the end-turns 113 flow through the end-turn utilizing portion 123 to be used in inducing an electric current in the rotor conductor 121. Accordingly, magnetic fluxes generated in the end-turns 113 of the stator 110 can be effectively utilized to increase the torque of the rotor 120, thereby enhancing efficiency of the induction motor 100.

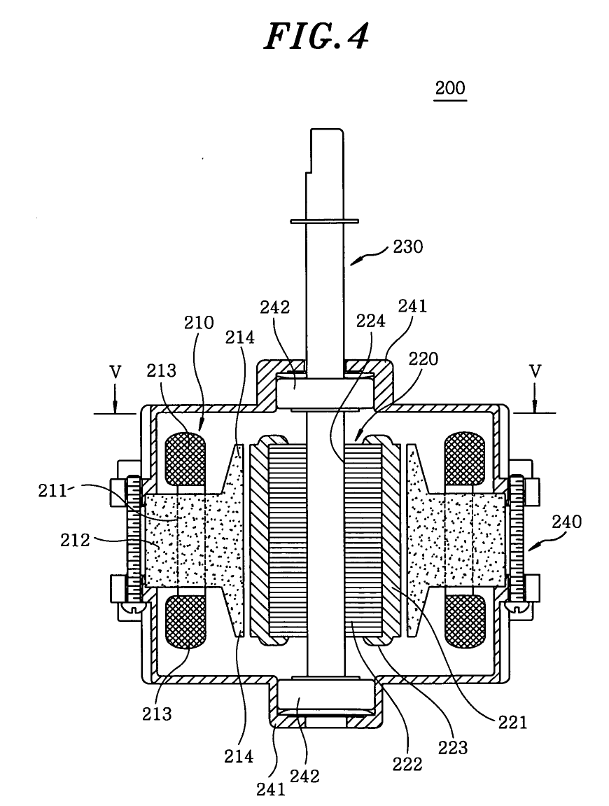

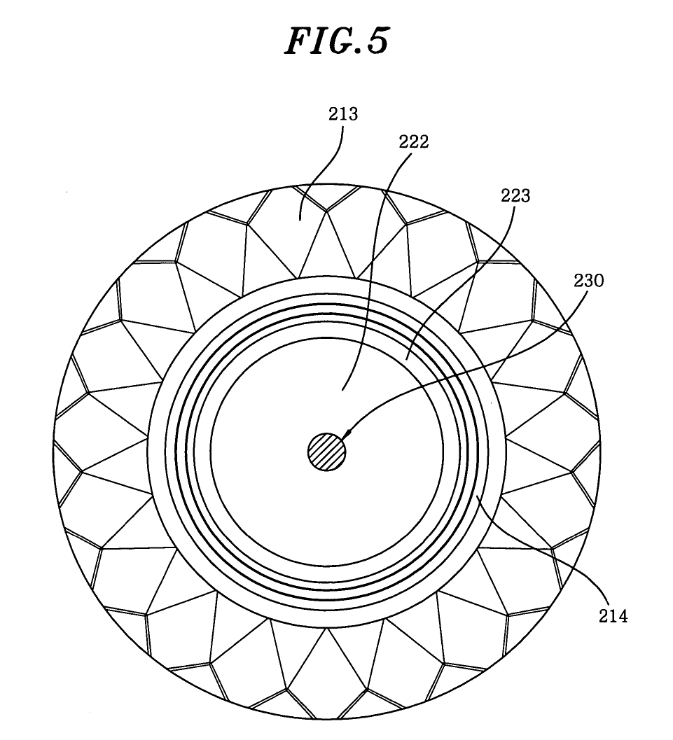

Hereinafter, a second embodiment of the present invention will be described with reference to FIGS. 4 and 5.

FIG. 4 is a cross-sectional view of an induction motor 200 in accordance with the second embodiment of the present invention, which makes effective use of end-turns of a stator to increase torque of a rotor. As illustrated, the induction motor 200 in accordance with the second embodiment includes a housing 240, a stator 210 fixedly secured to the inside of the housing 240, the stator 210 having stator cores 212 made of compressed soft magnetic powder, each of the stator 212 cores 212 provided at opposite axial ends with end-turn utilizing portions 214, a rotor 220 press-fitted onto a shaft 230 rotatably supported on shaft seats 241 of the housing 240 through bearings 242, the rotor 220 being disposed at the inner side of the stator 210 with a gap left between the stator 210 and the rotor 220, the rotor 220 and the shaft 230 being rotatable together. The rotor 220 has a rotor core 222 axially extended such that the opposite ends of the rotor core 222 are disposed to face the end-turn utilizing portions 214 of the stator 210 with the gap left therebetween.

The stator 210 includes coils 211 supplied with an alternating current for creating rotating magnetic fields and stator cores 212 made of a magnetic material, magnetic fluxes generated by the rotating magnetic fields flowing through the stator cores 212.

Each of the stator cores 212 has a plurality of slots (not shown) radially formed along an inner circumferential surface thereof. The coils 211 are wound in the slots in such a manner as to leave end-turns 213 at axial opposite ends of the stator cores 212. The end-turn utilizing portions 214 of each of the stator cores 212 extend in an axial direction in such a manner as to adjoin the corresponding end-turns 213.

In the illustrated embodiment, the end-turn utilizing portions 214 are formed at both axial ends of each of the stator cores 212 in an effort to maximize efficiency of the induction motor 200. Alternatively, a single end-turn utilizing portion may be formed only at one axial end of each of the stator cores 212.

Referring to FIG. 4, the end-turn utilizing portions 214 are integrally formed with each of the stator cores 212 and are protruded such that they are disposed between the end-turns 213 and the axial opposite ends of the rotor core 222, with gaps left between the end-turn utilizing portions 214 and the end-turns 213.

The magnetic fluxes generated in the end-turns 213 are transferred through the end-turn utilizing portions 214 to the rotor 220 to thereby induce an electric current in rotor conductors 221, which will be set forth later.

The stator cores 212 are molded by compressing soft magnetic powder to have the coil winding slots (not shown) and the end-turn utilizing portions 214. The iron-based particles of the soft magnetic powder are coated with an insulating material for the purpose of electrical insulation.

In order to compressively mold the soft magnetic powder into the stator cores 212, a molding cavity corresponding in shape to the stator cores 212 is provided within a compression-molding machine. The soft magnetic powder is filled in the molding cavity and then compressed by a punch or the like to form the stator cores 212 having the slots (not shown) and the end-turn utilizing portions 214. In this process, a lubricant and/or a binder may be added to the soft magnetic powder.

By the process of compression-molding the stator cores 212, the soft magnetic powder is made to form a soft magnetic composite having a three-dimensional shape. As opposed to a conventional stator cores made of identically shaped silicon steel plates, the stator cores 212 thus molded provides an increased flexibility of design, thus making it possible to form the end-turn utilizing portions 214 with ease.

The rotor 220 includes rotor conductors 221 for generating a torque through interaction between an electric current induced by the coils 211 and magnetic fluxes, and the rotor core 222 made of a magnetic material through which the magnetic fluxes flow.

The rotor conductors 221 are made of high conductivity metal, such as aluminum and copper, or a magnet. As similar to the coils 211, the rotor conductors 221 are fitted in slots of the rotor core 222 in parallel with an axial direction. The rotor conductors 221 are attached to an outer peripheral surface of the rotor core 222. Alternatively, the rotor conductors 221 may be disposed in the rotor core 222.

The rotor core 222 is axially extended such that the opposite ends thereof face the end-turn utilizing portions 214 with the gap left therebetween; and, therefore, the magnetic fluxes can be transferred from the end-turn utilizing portions 214 to the rotor core 222.

In the present embodiment, the rotor core 222 is formed by stacking a plurality of silicon steel plates. Alternatively, the rotor core 222 may be formed by compression-molding soft magnetic powder as similar to the stator cores 212. The rotor core 222 is provided with a plurality of slots into which the rotor conductors 221 are fitted and a shaft-receiving hole 224 through which the shaft 230 is inserted for fixation thereto. The rotor 220 is provided at its opposite ends with end rings 223 that interconnect the rotor conductors 221 to form a circuit.

There will now be described the operation of the induction motor having the afore-mentioned structure in accordance with the second embodiment.

If an alternating current is applied to the coils 211, rotating magnetic fluxes are formed in the stator cores 212 and interlinked with the rotor conductors 221 though the gap, thereby inducing an electric current in the rotor conductors 221. The electric current induced in the rotor conductors 221 cooperates with the magnetic fluxes to generate a torque. At this time, the magnetic fluxes formed in the end-turns 213 are transferred to the rotor core 222 through the gaps and the end-turn utilizing portions 214 to thereby induce an electric current in the rotor conductors 221. This improves efficiency of the induction motor compared with a conventional induction motor as shown in FIG. 1 wherein the magnetic fluxes of the end-turns are not utilized.

Thus, in accordance with the present embodiment, the magnetic fluxes generated in the end-turns 213 are effectively utilized to increase the torque of the rotor 220, thereby improving efficiency of the induction motor 200.

As described above, in the induction motor 200 of the second embodiment, the stator 210 has the end-turn utilizing portions 214 and the rotor 220 has the axially opposite ends extending to face the respective end-turn utilizing portions 214, so that the magnetic fluxes generated in the end-turns 213 of the stator 210 can be transferred through the end-turn utilizing portions 214 to the rotor 220 to induce an electric current in the rotor conductors 221. Accordingly, the magnetic fluxes generated in the end-turns 213 of the stator 210 can be effectively utilized to increase the torque of the rotor 220, thereby enhancing efficiency of the induction motor 200.

While the invention has been shown and described with respect to the preferred embodiments, it will be understood by those skilled in the art that various changes and modification may be made without departing from the scope of the invention as defined in the following claims.

What is claimed is:

1. An induction motor including a stator having stator cores and coils wound on the stator cores to leave end-turns, and a rotor rotatably provided at an inner side of the stator with a gap left between the stator and the rotor, wherein:
the rotor has a rotor core provided at an axial end with an end-turn utilizing portion extending radially outwardly in a confronting relationship with the end-turns of the stator with a gap left therebetween, so that magnetic fluxes generated in the end-turns flow through the end-turn utilizing portion of the rotor core.

2. The induction motor of claim 1, wherein the rotor core is made of compressed soft-magnetic powder.

3. The induction motor of claim 1, wherein the rotor core is also provided at the other axial end with the end-turn utilizing portion.

4. An induction motor including a stator having stator cores and coils wound on the stator cores to leave end-turns, and a rotor rotatably provided at an inner side of the stator with a gap left between the stator and the rotor, wherein:
each of the stator cores is provided at an axial end with an end-turn utilizing portion axially extended therefrom in a confronting relationship with one of the end-turns; and
a rotor has a rotor core axially extending to face the end-turn utilizing portions of the stator with a gap left therebetween, so that the magnetic fluxes generated in the end-turns are transferred through the end-turn utilizing portions to the rotor core.

5. The induction motor of claim 4, wherein the stator cores are made of compressed soft-magnetic powder.

6. The induction motor of claim 4, wherein each of the stator cores is also provided at the other axial end with the end-turn utilizing portion.
